(19) United States
(12) Patent Application Publication
(10) Pub. No.: US 2020/0341997 A1
(43) Pub. Date: Oct. 29, 2020

(54) OPTIMIZED DATA ACCESS

(71) Applicant: Instant Labs, Inc., Santa Clara, CA (US)

(72) Inventors: Hal Spitz, Oakland, CA (US); Eric Kiebler, Half Moon Bay, CA (US); Rene Stein, Palo Alto, CA (US); John McLaughlin, Roseland, NJ (US); Brigand Balleau, Albany, CA (US); Ajit Shantilal Shah, Portola Valley, CA (US)

(73) Assignee: Instant Labs, Inc.

(21) Appl. No.: 16/854,539

(22) Filed: Apr. 21, 2020

Related U.S. Application Data
(60) Provisional application No. 62/840,233, filed on Apr. 29, 2019.

(51) Int. Cl. G06F 16/25; G06F 16/22; G06F 16/23; G06N 20/00

(52) U.S. Cl. CPC G06F 16/258; G06F 16/2282; G06N 20/00; G06F 16/2237; G06F 16/2379

(57) ABSTRACT

In an embodiment, a process for providing optimized data access includes receiving at least a subset of data included in a set of origin data. The process includes transforming at least a portion of the subset of data in a manner associated with providing access to at least said portion of the subset of data in a manner that is optimized with respect to one or more parameters. The process includes providing access to the transformed subset of data to an associated set of one or more users

### CROSS REFERENCE TO OTHER APPLICATIONS

This application claims priority to U.S. Provisional Patent Application No. 62/840,233 entitled OPTIMIZED DATA ACCESS filed Apr. 29, 2019 which is incorporated herein by reference for all purposes.

### BACKGROUND OF THE INVENTION

Data may be organized and stored in various forms and types of systems, including without limitation, in or as structured, semi-structured, and unstructured data, ranging from files and streams of data to highly-structured databases. Owners of stored data typically desire that the data not be lost or corrupted and to have access to stored data as required for purposes for which the data exists.

Enterprises, government entities, and other owners of large quantities of data use database systems to store, update, analyze, and provide access to data. A common type of database in current use is the Relational Database Management System (RDBMS) and related systems. An RDBMS is based on the relational model of data. A general-purpose RDBMS is designed to service any kind of query, while a specialized RDBMS is designed for specific types of data or queries.

Modern database systems are able to handle large volumes of data and provide powerful tools to access and manipulate data. However, the power of modern database systems and the wide range of functionality provided can result in excessive latency and high resource consumption. Some tasks require the full capability of a modern RDBMS, while performing other tasks is more straightforward but still require substantial time and resources using an RDBMS or other traditional, full-function enterprise class database.

### BRIEF DESCRIPTION OF THE DRAWINGS

Various embodiments of the invention are disclosed in the following detailed description and the accompanying drawings.

FIG. 1 is a block diagram illustrating an embodiment of a system for optimized data access.

FIG. 2 is a block diagram illustrating an embodiment of a system for optimized data access having one data ingestion/transformation module and a plurality of data access nodes.

FIG. 3 is a block diagram illustrating an embodiment of a system for optimized data access having one data access node and a plurality of data ingestion/transformation modules.

FIG. 4 is a block diagram illustrating an embodiment of a system for optimized data access having a plurality of data access nodes and a plurality of data ingestion/transformation modules.

FIG. 5 is a block diagram illustrating an embodiment of a distributed access environment comprising two or more systems.

FIG. 6 is a block diagram illustrating an embodiment of a distributed access environment comprising two or more systems.

FIG. 7 is a block diagram illustrating an embodiment of a system for optimized data access.

FIG. 8 is a flow chart illustrating an embodiment of a process for optimizing data access.

FIG. 9 is a flow chart illustrating an embodiment of a process for data optimization.

FIG. 10A shows an example of origin data prior to data optimization.

FIG. 10B shows an example of a state of a set of data after a first optimization.

FIG. 10C shows an example of a state of a subset of data after a second optimization.

FIG. 11 is a flow chart illustrating an embodiment of a process for query optimization.

FIG. 12A shows an example of an index in a first state.

FIG. 12B shows an example of an index in a second state.

FIG. 13 is a flow chart illustrating an embodiment of a process for dynamically updating data access optimization.

FIG. 14 is a flow chart illustrating an embodiment of a process for providing data access optimized across access nodes.

FIG. 15 illustrates an example of data obtained in some embodiments.

FIG. 16 illustrates an example of data obtained in some embodiments.

FIG. 17 illustrates an example of data obtained in some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to provide optimized access to data are disclosed. In various embodiments, origin data, such as a subset of data stored in a database, such as an RDBMS-type database, is received by a system configured to access, ingest, and transform the data. For example, the system stores the data in one or more data structures and/or provides access to data via one or more different indexes to optimize data storage and/or access with respect to one or more optimization parameters. Examples of optimization parameters in various embodiments include one or more of CPU, storage device, or other resource usage; access latency, query response time, and/or other metrics; or any other cost, element, or metric with respect to which a data access-related operation may be optimized.

In various embodiments, optimized access to data is provided by receiving at least a subset of data included in a set of origin data. At least a portion of the subset of data is transformed in a manner associated with providing access to at least said portion of the subset of data in a manner that is optimized with respect to one or more parameters. Access is provided to a set of one or more users associated with the subset of data.

Although the examples below chiefly describe read access of the origin data, the techniques can be applied to both read and write access while supporting consistency and/or availability. For example, data can be optimized (transformed) while maintaining acceptable levels of consistency and availability. Existing models for providing consistency and/or availability in distributed data systems can be used.

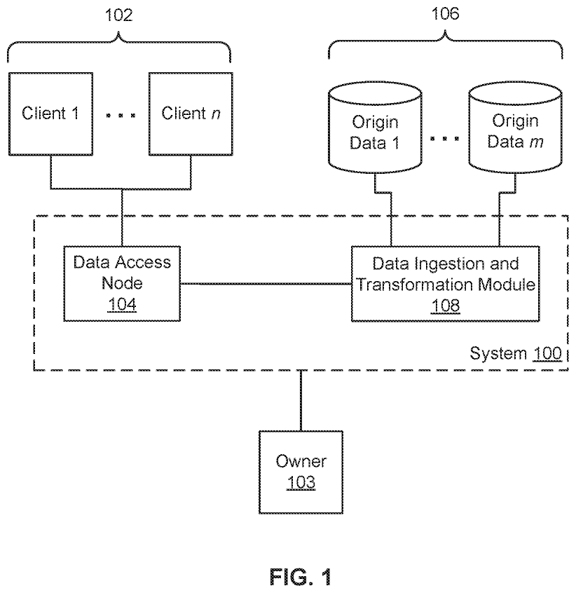

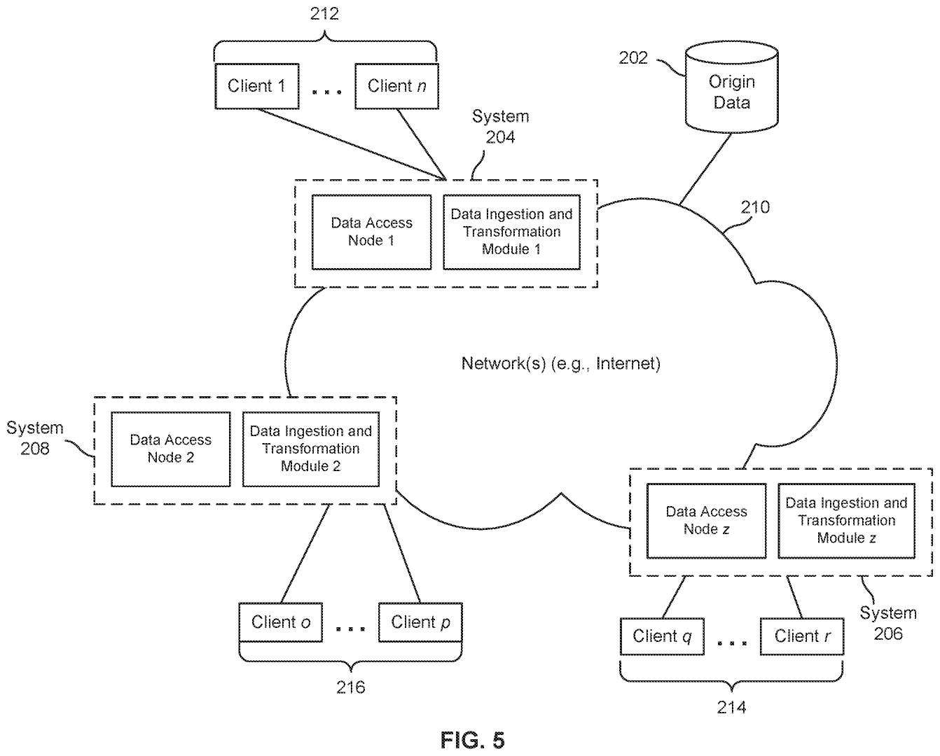

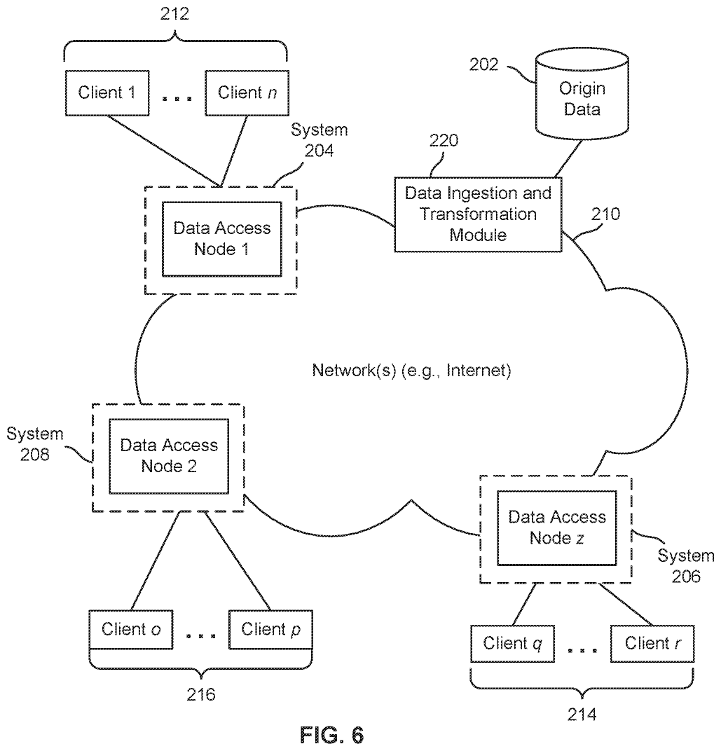

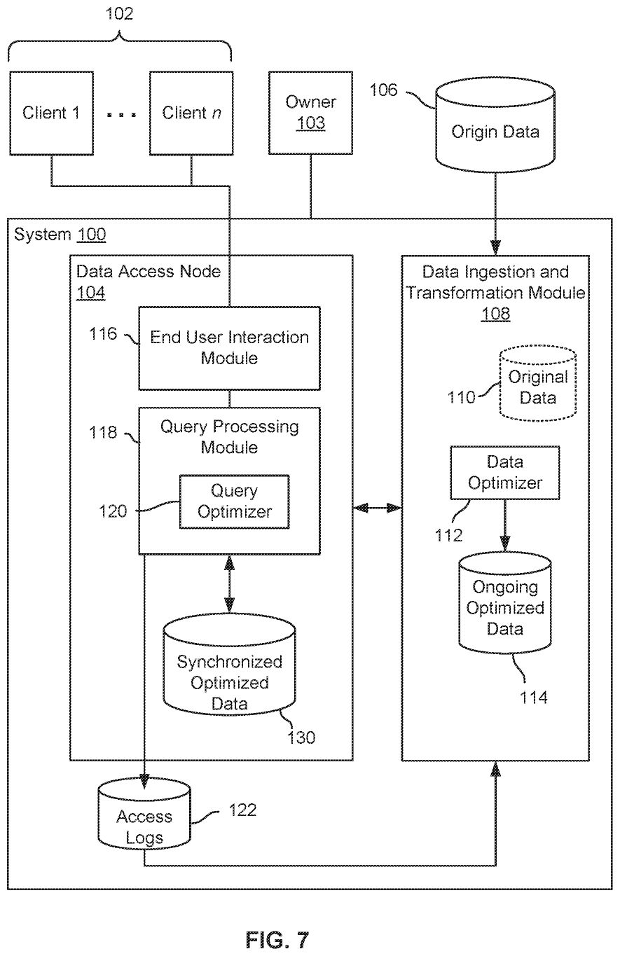

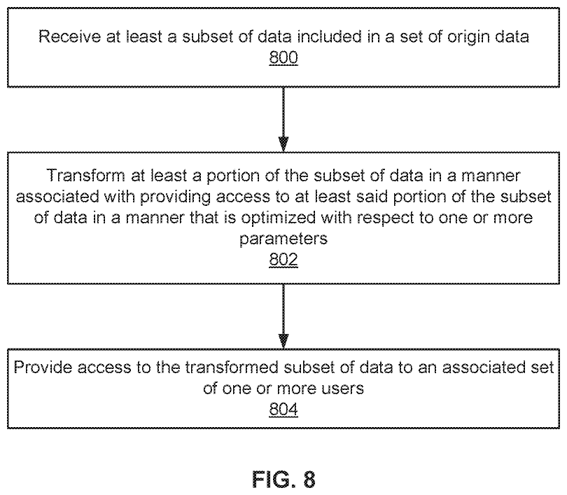

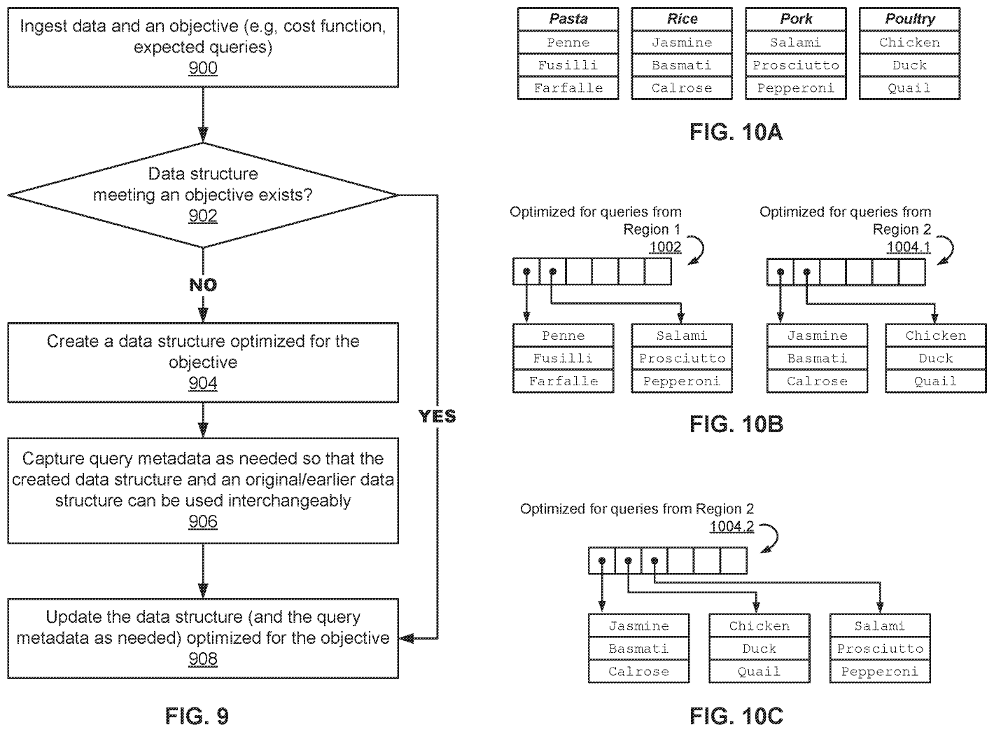

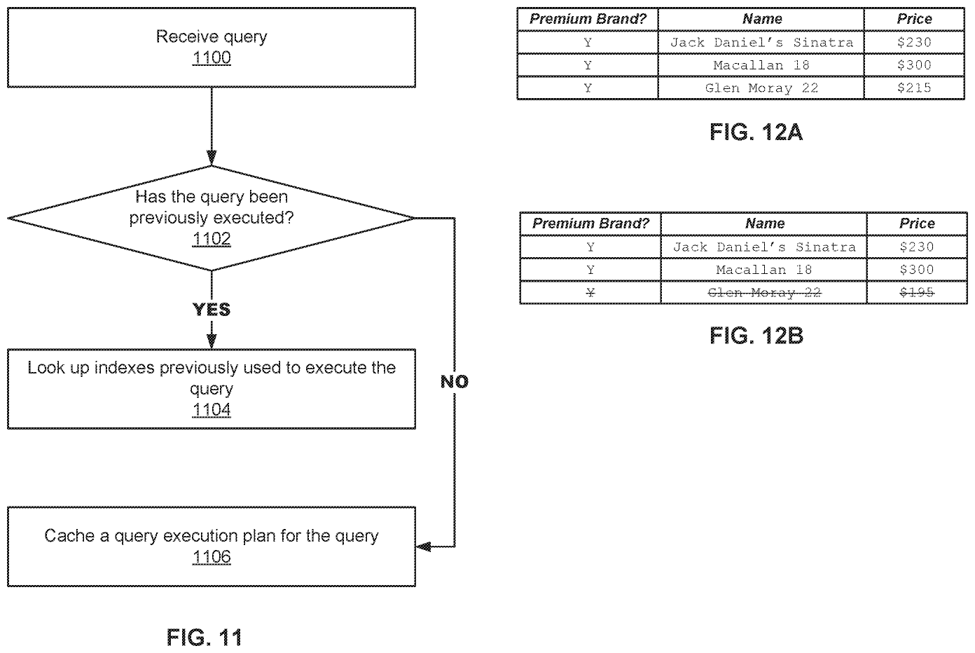

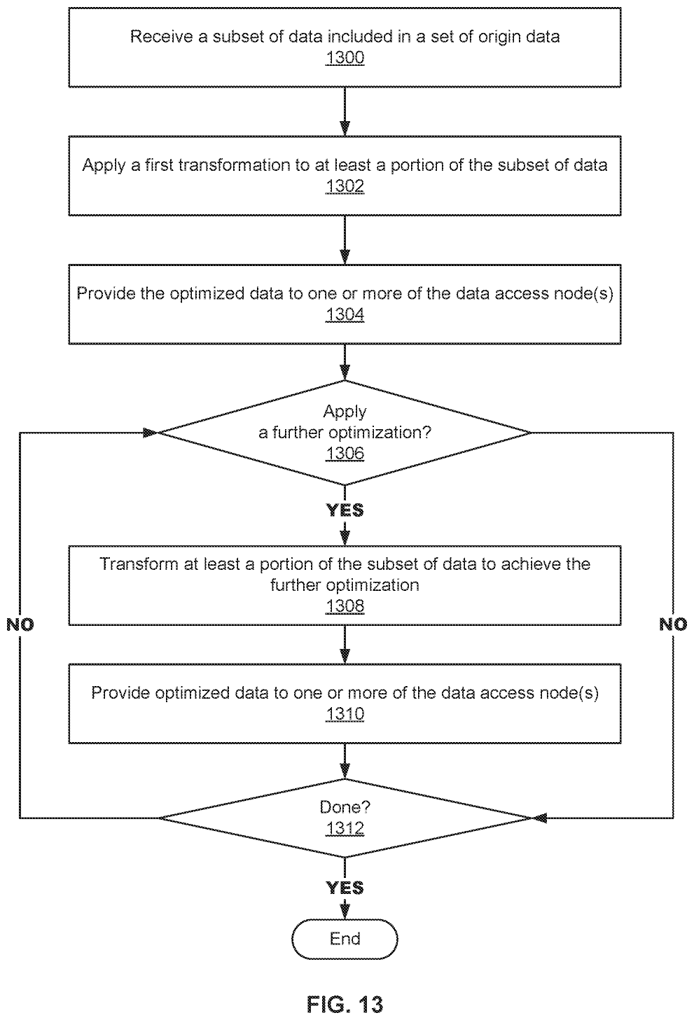

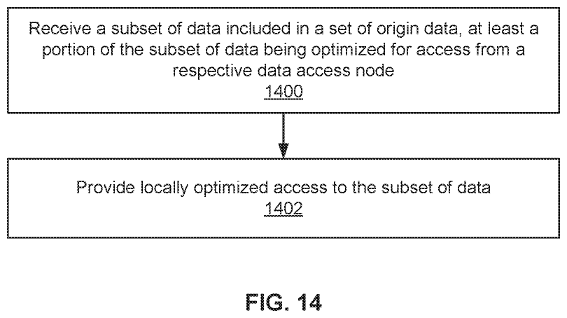

In various embodiments, techniques disclosed herein may be implemented on and/or with respect to a system, server, and/or service, such as in the examples shown in FIGS. 1-7 and described below. First, sample system configurations are described (FIGS. 1-4). Next, an environment with various data access nodes and data ingestion/transformation modules are described (FIGS. 5 and 6). Next, an example of a system including a data access node and a data ingestion/transformation module is described (FIG. 7). Then, a process for providing optimized data access (FIG. 8) including data optimization (FIG. 9) and query optimization (FIG. 11) are described. Then, a process for dynamically updating data access optimization (FIG. 13), and a process for optimizing data access across distributed nodes (FIG. 14) are described. In addition, some examples of data optimizations are described (FIGS. 10A-10C, 12A and 12B, and 15-17).

Table 1 includes example definitions of terms used throughout this disclosure.

TABLE 1

| Term | Description |
|---|---|
| Outcome | A set of conditions |
| Condition | A measurable evaluation of a state of part or all of a |
| | system or data structures |
| Constraint | A set of conditions to be maintained for part or all of a |
| | system or data structures |
| Policy | An expression combining at least an outcome and a |
| | set of constraints |
| Data Model | A particular arrangement of data |
| Data | A collection of data models |
| Organization | |
| Declarative | An expression that defines a desired outcome |
| Expression | |
| Imperative | An expression that specifies a sequence of actions |
| Expression | |
| Query | A declarative expression applied to a data model |
| Query Plan | An imperative expression derived from a query |
| Origin Data | Data considered as being “input” to the system |
| Data Model | A set of data embodied used a specific data model |
| Instance | |
| Action | A change made to part of a system or the system as a whole |
| Data Model | Changing data models to best suit desired outcomes |
| Optimization | |
| Data Content | Changing the contents of data model instances to best suit |
| Optimization | desired outcomes |
| Data | Using Data Model Optimization and/or Data Content |
| Optimization | Optimization to best suite a desired outcome |
| Query | Generating and/or modifying query plans to best suit |
| Optimization | desired outcomes |
| Query Plan | Generating and/or modifying a specific query plan to best |
| Optimization | suit a desired outcome |
| Data Access | Using Data Optimization and/or Query Optimization to |
| Optimization | best suit a desired outcome |

FIG. 1 is a block diagram illustrating an embodiment of a system for optimized data access. The environment shown here includes one or more origin databases 106 storing origin data, one or more clients 102 configured to express queries and receive results, owner 103 that defines policies, and system 100 configured to provide optimized data access. System 100 and/or the other components shown here may be implemented by one or more physical devices.

Owner 103 defines policies, where a policy describes a desired outcome and any constraints. In various embodiments, a policy defines desired outcomes including but not limited to matching policy for machine learning or matching policy performance, cost, or business objectives. A policy can be expressed as one or more cost functions, high level objectives, sets of rules, etc. as further described herein. For example, owner 103 is an online purveyor of foods who sells products in multiple locations throughout the world. The owner's inventory corresponds to origin data stored in the origin databases 106. Clients 102 are shoppers who access the owner's online website catalog/marketplace to order goods for delivery to their homes. The owner can define a policy to minimize response times so when a client queries for a particular category of foods, the relevant items are quickly loaded for the client to review on their Web browser. System 100 optimizes data access to meet the policy defined by the owner by reorganizing and/or transforming data, queries, and query results using the techniques disclosed herein. This improves the user experience of clients 102 while improving the functioning of devices, computers, and processors involved by reducing processing cycles and memory used.

System 100 includes data access node 104 and data ingestion and transformation module 108. Data access node 104 receives and responds to queries from clients 102. The data access node reorganizes and/or transforms data for example by performing the process of FIG. 9 to optimize data access for the clients. Data ingestion and transformation module 108 ingests data from origin databases 106. The data ingestion and transformation module reorganizes and/or transforms queries and query results for example by performing the process of FIG. 11 to optimize data access for the clients. As further described below, data access node 104 and data ingestion and transformation module 108 may cooperate by sharing information to improve a user experience for clients 102 while meeting a policy defined by owner 103. In various embodiments, system 100 includes an intermediate store containing one or more data model instances as further described in FIG. 7.

One or more origin databases “Origin Database 1” to “Origin Database m” (collectively referred to as “origin databases 106”) is configured to store origin data. Although referred to as an origin database for simplicity, the origin database may be any type of data source or combination of data sources including but not limited to a flat file, a log, or a device from which data is streamed. Origin data described in the examples herein originates from origin databases 106. Origin data can be distributively stored in the one or more origin databases or can be stored in a single one or subset of the origin databases so that the origin data is associated with (e.g., comes from) at least a portion of one or more origin databases 106.

Origin databases 106 may include or be implemented by a production, reference, and/or “system of record” database of an enterprise or other data owner. In some embodiments, origin database 106 may be a full feature relational database, such as an Oracle™ database. While for simplicity FIG. 1 shows clients 102 connected to data access node 104 by a line, in various embodiments the line represents connection via the Internet and/or one or more other networks.

Data access node 104 is communicatively coupled to one or more clients “Client 1” to “Client n” (collectively referred to as “clients 102”), permitting clients 102 to access data via a data access node 104. In various embodiments, data access node 104 comprises one or more functional modules and data structures (e.g., a local database or other local copy of data) provided via one or more network-connected physical computer systems, such as one or more physical servers.

Data ingestion and transformation module 108 is configured to ingest, transform, and store data received from origin databases 106. In various embodiments, the data comprises a subset of data from origin database 106. A more detailed example of system 100 is shown in FIG. 7.

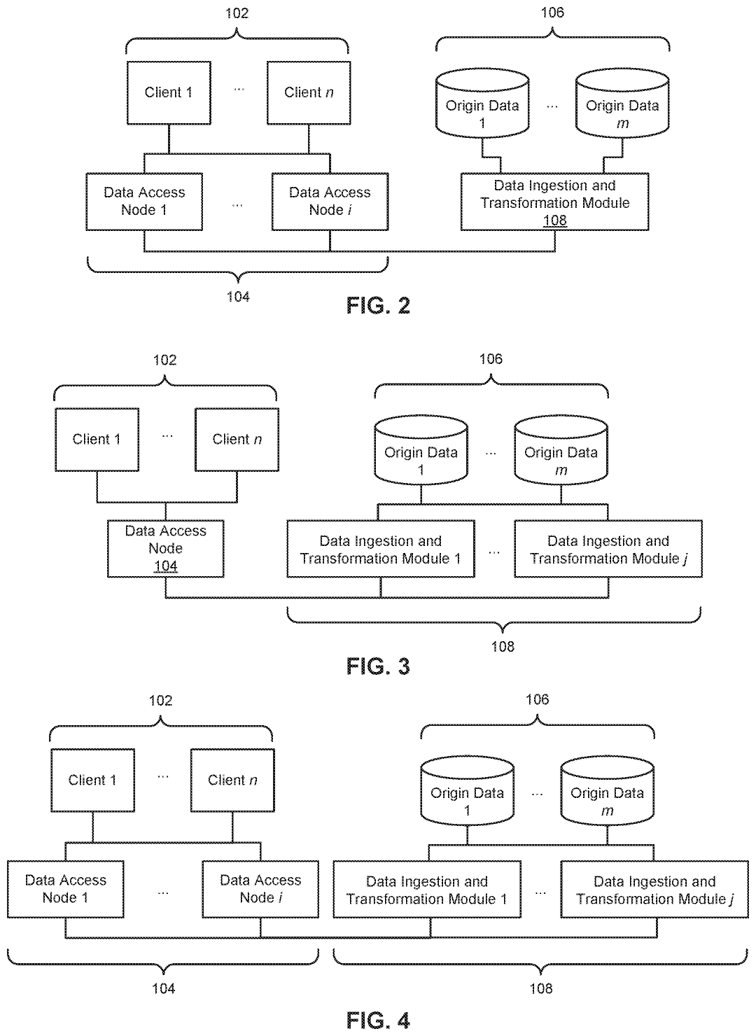

In this example, data access node 104 is remote from origin databases 106. In other embodiments, origin databases 106 are collocated with the system or components of the system such as data access node 104 or data ingestion and transformation module 108. In various embodiments, system 100 includes one or more data access nodes and one or more data ingestion and transformation module as shown in FIGS. 2-4. Each of the components shown in the FIGS. 2-4 are like their counterparts in FIG. 1 unless otherwise described.

FIG. 2 is a block diagram illustrating an embodiment of a system for optimized data access having one data ingestion/transformation module and a plurality of data access nodes. In this example, clients 102 are configured to access data via several data access nodes 104. Each client 102 may be associated with a specific one or subset of the data access nodes. As further described below, the association of a client with a data access node may be optimized such as by geographical/network proximity or type of data desired or likely to be requested. Here, a single data ingestion and transformation module 108 is configured to transform and optimize origin data from origin databases 106. Each of the data access nodes 104 is communicatively coupled with the data ingestion and transformation module 108 to exchange data and cooperate in transforming and optimizing the data according to the techniques disclosed herein.

FIG. 3 is a block diagram illustrating an embodiment of a system for optimized data access having one data access node and a plurality of data ingestion/transformation modules. In this example, clients 102 are configured to access data a single data access node 104. Here, several data ingestion and transformation modules 108 are configured to transform and optimize origin data from origin databases 106. Each data ingestion and transformation module 108 may be associated with a specific one or subset of the origin databases 106. The data access node 104 is communicatively coupled with each of the data ingestion and transformation modules 108 to exchange data and cooperate in transforming and optimizing the data according to the techniques disclosed herein.

FIG. 4 is a block diagram illustrating an embodiment of a system for optimized data access having a plurality of data access nodes and a plurality of data ingestion/transformation modules. This example combines the features of FIGS. 2 and 3, where each of the clients 102 may be associated with a specific one or subset of the data access nodes and each of the data ingestion and transformation modules 108 may be associated with a specific one or subset of the origin databases 106.

In various embodiments, techniques disclosed herein may be used in an environment and system comprising a distributed set of systems. For example, the system shown in the figures above can be included in (e.g., part of) a larger system that includes several sets of data access nodes and data ingestion and transformation modules as shown in FIGS. 5 and 6.

FIG. 5 is a block diagram illustrating an embodiment of a distributed access environment comprising two or more systems. In various embodiments, one or more or all of the systems 204, 206, and 208 may be implemented as system 100 of FIG. 1. For example, each system 204, 206, 208 includes a data access node and a data ingestion and transformation node. In various embodiments, the environment includes a data ingestion and transformation module shared by the systems and each system includes a data access node corresponding to FIG. 2 and further described with respect to FIG. 7. In various embodiments, the environment includes a data access node shared by the systems and each system includes a data ingestion and transformation module corresponding to FIG. 3. Clients 212, 214, and 216 may be connected to systems 204, 206, and 208 by one or more networks and/or Internet 210. Similarly origin database 202 may be connected to systems 204, 206, and 208 by one or more networks and/or Internet 210. One or more data access nodes or one or more data ingestion and transformation modules may be located on the edge, e.g., closer to the clients to decrease response times and reduce bandwidth needed to communicate with associated clients.

Each system, client 212, and origin database 202 is like its counterpart in FIGS. 1-4 and 7 unless otherwise described herein. In this regard, an origin data source is represented by origin database 202 but may be implemented by one or more data sources as described with respect to origin databases 106.

In the example shown, access to data included in origin database 202 is provided via distributed systems, represented by systems 204, 206, and 208. Systems 204, 206, and 208 may be distributed geographically, logically, or otherwise. Here, systems 204, 206, and 208 are distributed geographically and are shown to be configured to provide access to a local set of clients 212, 214, and 216, respectively.

In various embodiments, each set of clients 212, 214, and 216 may be configured to access data via one or more of associated data access nodes in systems 204, 206, and 208. The clients may access different origin databases. For example, the system accesses data from different databases, optimizes the combined data for access by the clients. The clients may be associated with different and potentially overlapping subsets of data. Application level requests from clients 212, 214, and 216 are routed, e.g., by IP address, application instance identifier, user agent identifier, or otherwise, to corresponding data access nodes 204, 206, and 208, respectively. For example, routing is influenced by location, client type, or the like.

In various embodiments, each system 204, 206, and 208 stores an associated subset of data from origin database 202. Each may store different data than one or more other of the systems 204, 206, and 208. Each may store data in the same or a different format and/or data structures as other of the systems 204, 206, and 208. For example, a first system may store a set of data in one set of one or more data structures, while a second system may store the same data in a different set of one or more data structures. In various embodiments, the system operates on a production database or copy of the production database, and selects another data structure to organize the subset of data based on a set of queries. Data may be distributed in a variety of ways including by separating data based on target audiences (such as shoes on one server and dresses on another server), geographical location, performance characteristics, or the like.

Examples of performance characteristics include, without limitation, latency of queries or relative value of queries. For example, low-latency queries, demanding the earliest possible responses, are separated from queries without such needs. Low-latency queries benefit from having data organized in ways that match their desired result structure. Transforming origin data to match the query's needs improves throughput and reduces latency. Distributing such transformed data to nodes receiving the most of the aforementioned queries further improves latency for individual queries, and improves throughput for the node as a whole. As an example, a query requesting the price for a stock selected through membership in any of several sector criteria might be considered a low-latency query, whereas the total number of outstanding shares would not be considered as such.

As another example, queries considered to be more valuable, such as those made at a critical juncture in a workflow, are separated from other queries by organizing the data to ensure that the query will complete with reduced latency and the least likelihood of failure. Suppose a valuable query requires accessing all the information concerning a user's e-commerce shopping cart, which the system disclosed herein optimizes by ensuring that all cart data is available to all nodes and is organized to minimize the time needed to implement a successful checkout process. If that query had less value, the data may be organized differently and involve more manipulation within the data nodes. Less valuable queries might take longer than others or potentially receive errors and require resubmission with less detriment to the user experience.

Likewise, in various embodiments, each system may index (the same, partially the same, and/or different) data differently than one or more other systems. For example, indexes or index types are selected based on a predominant query for node such as a database instance.

Each system 204, 206, and 208 may be optimized differently than one or more other systems. For example, each system 204, 206, and 208 may be optimized independently of one or more other systems based on the subset of data stored at that system, the queries anticipated to be received at that system, local (e.g., regional, national) preferences and/or regulatory or other requirements of a locale with which a given data access node is associated, different optimization parameters, different weighting of optimization parameters, etc. Each data ingestion and transformation module of systems 204, 206, and 208 may perform transformations differently than one or more other data ingestion and transformation modules.

The systems may coordinate with each other to share optimizations. In various embodiments, the systems may coordinate with each other to self-organize to share work including by optimizing or transforming at a least a first portion at a first system and at least a second portion at a second system. As an example, consider a query A whose repeated execution becomes a sizeable part of data node N1's bandwidth. Node N1 optimizes the query as best it can, but determines that a restructuring of the data would make the query substantially faster. Node N1 creates a new representation of the data being queried that matches the queries' needs, comprising any subset of the full combination of data, index, and formatted results.

The benefits of data reorganization can be shared with other nodes as follows. In various embodiments, node N1 shares the determination that this data reorganization would be beneficial with the data ingestion and transformation module 108. Module 108 then creates a data transformation usable by other data nodes without requiring the other nodes to perform all and/or part of the transformation work locally. When desired, either the data node or the transformation module 108 may decide to change the data organization to suit current needs, such as reducing resource utilization, addressing a different query's needs, etc. Communications between data nodes need not go through a transformation engine as various embodiments of the communication pathways are possible.

FIG. 6 is a block diagram illustrating an embodiment of a distributed access environment comprising two or more systems. Each of the components is like its counterparts in FIGS. 1-4 and 7 unless otherwise described herein. The configuration of this example environment differs from the one shown in FIG. 5 and corresponds to the one shown in FIG. 2. Here, a data ingestion and transformation module 220 is shared by systems 202, 204, and 206. Each system includes a data access node.

Although not shown in FIG. 5 or 6, further environment configurations are possible. For example, a data access node can be shared by the systems, where each system includes a data ingestion and transformation module, which corresponds to FIG. 3.

FIG. 7 is a block diagram illustrating an embodiment of a system for optimized data access. System 100 includes data access node 104 and data ingestion and transformation module 108. Clients 102, origin database 106, data access node 104, and data ingestion and transformation module 108 are like their counterparts in the other figures unless otherwise described herein.

Data access node 104 is configured to communicate with clients 102 and to optimize query processing. Data ingestion and transformation module 108 is configured to communicate with origin database 106 and optimize data. Data ingestion and transformation module 108 and data access node 104 are communicatively coupled, and cooperate to improve clients' user experience by making data more readily accessible among other performance improvements.

For example, data access node 104 polls data ingestion and transformation module 108 for new data, which may be different from a previous poll. The new data is stored in ongoing optimized data store 114. Synchronized optimized data store 130 stores the new data. This enables data access node 104 and data ingestion and transformation module 108 to share information while working independently to perform optimizations, the results of which may be combined in various embodiments.

Data access node 104 and data ingestion module 108 may cooperate as follows. Suppose some data from different tables in origin database 106 are combined into a table in ongoing optimized data store 114 or vice versa (the table is in synchronized optimized data 130). A specific index is selected to be used when searching based on information in synchronized optimized data store 130 and query trends identified by data access node 104. Data ingestion and transformation module 108 generates statistics about the data that are useful to data access node 104 or vice versa. Data ingestion and transformation module 108 helps to perform part of a useful query optimization such as an expensive SQL JOIN. Then the data access node 104 creates indexes on the resulting JOIN table.

Data ingestion and transformation module 108 includes data optimizer 112, ongoing optimized data store 114, and optionally a copy of original data 110. Data ingestion and transformation module 108 is configured to transform data received from origin database 106. In various embodiments, the data ingestion and transformation module performs the transformation according to a set of transformations determined by data optimizer 112.

Data optimizer 120 may include and/or be implemented by an optimization module, layer, and/or process/function completed by cooperation between data access node 104 and data ingestion and transformation module 108. In various embodiments, data optimizer 112 comprises a machine learning layer configured to determine an optimal set of data structures and indexes to store and provide access to data received from origin database 106.

Initially, in some embodiments, data may be stored only in its original form (e.g., in store 110). Over time, data optimizer 112 determines optimal data transformations, such as storing data from two or more relational tables in a single compound data structure, and/or indexing data differently than it may be indexed at origin database 106. Referring further to FIG. 7, transformed data from origin database 106 is stored in ongoing optimized data store 114. Data optimization may be an ongoing or repeated process that updates the optimized data stored in store 114.

Data access node 104 includes end user interaction module 116, query processing module 118, query optimizer 120, and synchronized optimized data store 130. Requests (e.g., database queries, application-level requests that require queries to be performed, etc.) from client systems 102 are received and processed by end user interaction module 116. In some embodiments, end user interaction module 116 may include application code, user interface code, etc. In some embodiments, end user interaction module 116 may be configured to receive and respond to SQL and/or other queries from clients 102 and/or implied by and/or otherwise required to be performed to respond to requests received from clients 102.

Queries required to respond to requests from client systems 102 are processed by query processing module 118, which includes a dynamic query optimizer 120. Query optimizer 120 may include and/or be implemented by an optimization module, process, and/or layer. In various embodiments, query optimizer 120 determines an optimized manner in which to perform a given query, e.g., applying conventional query optimization techniques in light of what is known about how the data has been stored and indexed in optimized data 114.

In the example shown, data optimizer 112 included in data ingestion and transformation module 108 performs optimization processing to determine the optimal data structure(s) and/or format in which to store and/or index data ingested by data ingestion and transformation module 108. In various embodiments, the optimization processing is performed offline in batch operations, e.g., using the original data 110. In other embodiments, a remote optimization service may perform optimization processing.

In various embodiments, access logs 122 generated by query processing module 118 and/or received from other, remote data access nodes, are used by optimizer 112 to determine and/or update optimizations to transform and/or index data received from origin database 106. Over time, data in origin database 106 may change, as may the subset of data ingested and stored in local data store 110, queries received from clients 102, priorities of the data owner, etc. Data received from origin database 106 is stored in its original, as-received format in original data store 110. In various embodiments, data optimizer 112 and/or another optimization module, system, or service uses original data 110 and data access patterns and/or statistics (e.g., from logs 122) to determine an updated optimal set and type of data structures and/or indexes to be used to store and provide access to data received from origin database 106. In some embodiments, the data optimizer 112 performs optimization processing (e.g., using machine learning, artificial intelligence, and/or other techniques), periodically (e.g., nightly), continuously, or in response to a trigger, until currently optimized to current conditions, etc., in an ongoing effort to improve data access.

While in various embodiments techniques disclosed herein may be implemented on and/or with respect to a system such as system 100, in various other embodiments techniques disclosed herein may be implemented on one or more systems different in one or more respects from system 100.

Techniques are disclosed to provide optimized access to data that resides in an origin database, such as a fully-functional enterprise class database system. In various embodiments, techniques disclosed herein are implemented as a device and/or one or more software applications running on a computer with a database that automatically optimizes data access for one or more of performance, resource optimization, cost management/optimization (e.g., for cloud-based computing and/or storage resources for which payment is a function of use/consumption, etc.), load management for different utilization curves, etc.

In various embodiments, a system as disclosed herein includes one or more components to perform or provide one or more of the following: a system/algorithm to identify when and what changes to make to data, dynamically optimized indexes, dynamically allocated memory, and a dynamically distributed data architecture which can be used alone or in combination to optimize the performance and/or cost profiles.

In some embodiments, the techniques disclosed herein are implemented on or with respect to a system such as system 100 of FIG. 1 or FIG. 7 and/or a system and environment comprising a distributed set of data access nodes, such as the system and environment shown in FIGS. 5 and 6. In some embodiments, the techniques disclosed herein are implemented with respect to systems other than as shown in FIGS. 1 and 7 and/or in system and environments other than as shown in FIGS. 5 and 6. In various embodiments, one or more techniques and features described below may be implemented.

FIG. 8 is a flow chart illustrating an embodiment of a process for optimizing data access. This process may be implemented on system 100 of FIGS. 1 and 7.

In the example shown, the process begins by receiving at least a subset of data included in a set of origin data (800). The ingested data may comprise a subset of data from a data source, sometimes referred to herein as an “origin” database, as in FIG. 1. The set of data ingested from the origin database may include one or more of a subset of data specified explicitly by an administrative user, such as specific tables or portions thereof, data associated with queries specified and/or identified by an administrative user, e.g., via an administrative user interface, and/or data and/or queries observed to have been accessed and/or used by an automated process and/or by automated examination of log data, data anticipated to be access in the future based on a model or other analysis performed via machine learning, etc.

Data to which optimized access is to be provided can be downloaded from the origin database initially in a format in which the data is stored at the origin database. For example, tables or portions thereof may be ingested. In various embodiments, optimized access is provided to data using a local copy of data ingested from a data source. For example, referring to FIG. 7, the received data is stored in original data store 110.

In various embodiments, data is updated over time. For example, a publish-subscribe approach is used to ensure that any changes made at the origin database to data that has been ingested and/or to which optimized data access is provided as disclosed herein are propagated to a data access node configured to provide optimized access to such data as disclosed herein. For example, in some embodiments, a data access node as disclosed herein subscribes to be notified of any changes made at the origin database to data that has been ingested to the data access node. Upon receiving a notification that data has been changed, the data access node obtains the changed data.

As another example, data updates are received as a batch, e.g., according to a predetermined schedule. Data is updated/received in response due to an event-based trigger such as a query, a type of query, a source data being changed, a source data being accessed, a quantum of change in source data, or an external event. An external event may be a marketing campaign, a flash sale, or any other type of event as further described below.

In various embodiments, techniques other than publish-subscribe or event triggers may be used to ensure that data as stored at a data access node as disclosed herein remains consistent with corresponding data as stored at the origin database.

In various embodiments, all queries are transactionally read and/or write consistent. For example, when a transaction is initiated, the highest transaction ID system-wide is recorded. As data is read to perform an operation associated with the transaction, only pages that have that transaction ID or lower are read. When a new write transaction is initiated (e.g., to update data that has been changed at the origin database), the global transaction ID is incremented by 1, so no read transaction started prior to the update is aware of the write transaction's data, because the read transaction would have a lower transaction ID than the page to which the write transaction has written. In various embodiments, the system serializes write transactions, ensuring that write transactions are automatically read/write consistent. This example of maintaining read consistency is merely exemplary and not intended to be limiting. Other techniques for maintaining read or write consistency such as those described herein with respect to supporting consistency and availability may be used.

The process transforms at least a portion of the subset of data in a manner associated with providing access to at least said portion of the subset of data in a manner that is optimized with respect to one or more parameters (802). Upon being received, data is transformed and stored in a format and set of data structures optimized to provide data access in a manner that achieves one or more objectives and/or criteria associated with one or more of performance, cost, resource consumption, etc. In various embodiments, at least a portion of the subset of data (available origin data for example) is transformed in a manner that best implements a current policy to meet policy objectives within policy constraints.

In various embodiments, a manner by which at least a portion of the subset of data is transformed includes data optimization. The data is transformed to optimize storage and/or access. An example process for data optimization is shown in FIG. 9.

In various embodiments, providing access to at least said portion of the subset of data in a manner that is optimized with respect to one or more parameters includes query optimization. An example process for query optimization is shown in FIG. 11. The transformation may be halted in response to obtaining a threshold number of results.

The process provides access to the transformed subset of data to an associated set of one or more users (804). For example, in response to a query by a user, the process provides relevant data. Referring to FIG. 1, system 100 performing this process provides data to clients 102 in response to a query made by the clients. Compared with conventional systems, the process provides the subset of data more quickly because the data and query optimizations reduce the time it takes to accurately provide a result back to a user.

FIG. 9 is a flow chart illustrating an embodiment of a process for data optimization. This process may be implemented on or by data optimizer 112 of FIG. 7. This process can be performed as part of another process such as 802 of FIG. 8. The process will be explained with reference to the example shown in FIGS. 10A-10C. FIG. 10A shows an example of origin data prior to data optimization, FIG. 10B shows an example of a state of a set of data after a first optimization, and FIG. 10C shows an example of a state of a subset of data after a second optimization.

Returning to FIG. 9, the process begins by ingesting data (900). The data can include one or more sets of data in various data structures. For example, the data can be the subset of data included in a set of origin data from 800. In various embodiments, data is ingested from a relational database in the form of two or more relationally organized tables (data in multiple tables). FIG. 10A shows an example of data from the inventory of an online purveyor of foods. Suppose this online merchant has customers in various countries with various interests. The ingested data is stored in separate tables for each category of food. Here, there are four categories: pasta, rice, pork, and poultry. The number of rows and columns in this example and other examples are merely exemplary and not intended to be limiting. For example, additional columns (fields) can be store additional information such as the price of the item in the same row, the quantity or availability, etc.

The data optimization process can create data structures or re-arrange items in the ingested data to meet an objective such as a cost function or for types of queries expected to be executed against the data as follows.

The process determines whether a data structure meeting an objective exists (902). If the data structure does not exist, then the process proceeds to create a data structure optimized for the objective (904). Examples of objectives include expected queries, cost functions, and high-level objectives. For example, the ingested data is reorganized into a compound object and/or other data structure (also called an “index”) or format optimized for the types of queries expected to be executed against the data. Examples of compound data structures include arrays and/or other data structures capable of storing multiple values and/or a mix of different types of value. In some embodiments, data may be stored in a row or other structure that includes fields (e.g., columns) in which multiple values are stored, e.g., in an array or table, rather than storing just one value.

In various embodiments, the compound or other data structure(s) in which data is stored at the data access node are determined and constructed to optimize specific data access operations. For example, in some embodiments, queries anticipated to be processed with respect to a set of data stored across multiple relationally organized tables may be stored in a single data structure (e.g., table) in which at least some data fields (columns) store arrays, tables, or other structures containing multiple data values.

In some embodiments, a subset of ingested data, e.g., a subset comprising only data actually needed to respond to expected queries, may be stored. Typically, database records may contain numerous values of little practical use on a daily basis, and in some embodiments a system as disclosed herein stores only that subset of each record that is expected to be needed to respond to anticipated queries. In some embodiments, a system as disclosed herein would observe which records are commonly accessed, and make available to the administrator the ability to “filter” the data to that node, reducing costs and/or improving performance.

FIG. 10B shows two examples of data structures that are created. Data structure is an array having elements each storing one or more values. Referring to data structure 1002, index 0 points to three values: penne, fusilli, and farfalle and index 1 points to three values: salami, prosciutto, and pepperoni. The values are derived from the ingested data of FIG. 10A. Data structure 1002 is optimized for the objective of quick response times for queries from Region 1. For example, market research shows that Italian customer tend to most frequently search and purchase pasta and pork items so these items are stored in data structure 1002 and other items (such as poultry) are not stored in the data structure to decrease latency for queries from Region 1.

By contrast, the market research shows that customers from Region 2 tend to most frequently search and purchase rice and chicken items. Thus, data structure 1002 would not work well for Chinese customers because it contains data that is not likely to be queried. Instead, a different data structure 1004.1 is created and optimized to decrease latency for queries from Region 2. Array 1004.1 stores a subset of the items in FIG. 10A, namely those items that are expected to be needed to respond to anticipated queries while other items (e.g., of little practical use on a daily basis) are not stored in the array.

Returning to FIG. 9, the process captures query metadata as needed so that the created data structure and an original (or earlier version of a) data structure can be used interchangeably (906). Sometimes, after creating a data structure, existing queries do not work with the data structure. This can be addressed by capturing metadata for query compatibility to allow for a transitive transformation back and for the between different forms (data structures). The metadata allows existing queries to be used so that the query does not need to be changed because the data was transformed in some ways as to make the existing queries invalid. The process captures sufficient metadata so that the transformed data is treated as an equivalent of an original/earlier version of the data for purposes of access and update (e.g., insert, update, delete). If existing queries work on the transformed data, then this step can be omitted.

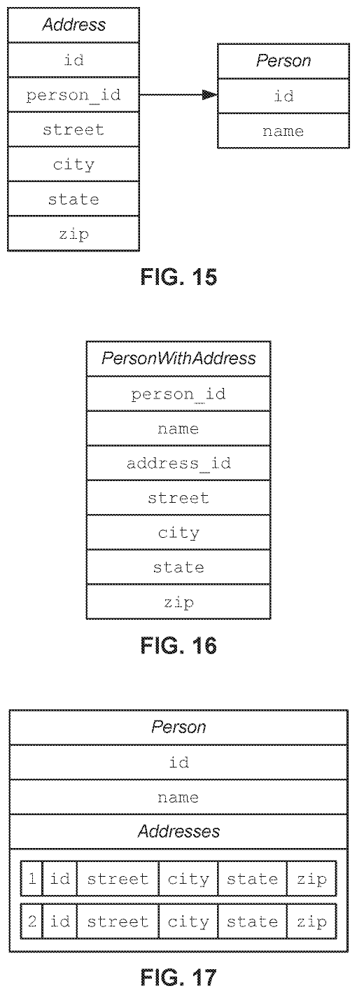

If a data structure already exists, the process updates the data structure optimized for the objective (908). Over time, an existing data structure may not perform as well for an objective, so the data structure may be updated to better meet the objective or changed objectives. Suppose that a new cooking show broadcast in Region 2 causes an increase in interest in cured pork products. FIG. 10C shows an example of a data structure that updated according to an embodiment. Data structure 1004.1 can be updated resulting in data structure 1004.2 by adding an element at index 2 to include three values: salami, prosciutto, and pepperoni. Additional examples of data transformations are shown in FIGS. 15-17. In various embodiments, the process returns to 900 to perform further optimizations or the process may simply terminate.

One type of data structure that can be created at 904 and updated at 908 is an index. For example, one or more indexes optimized to provide data access ingested and transformed as disclosed herein are created and/or altered. Computer systems use complex data structures (indexes) for faster access to data once the data grows beyond a minimal number of items. The choice of the type of index typically is driven by the number of indexable items, read vs. write access patterns, the number of computer resources available, etc. Each of these different indexing implementations has very specific access patterns for which they deliver exceptional, good, average, or poor performance. But the overall performance of indexes is based on the index as a whole, typically leading to less than optimal performance and resource utilization for parts of the index.

In various embodiments, access patterns, heuristics, and machine learning are used to identify access patterns that would benefit from alternative data structures on parts of the index. The system can optimize for read vs. write performance, space vs. time, compute resources, or a combination of these variables. Alternative index types (e.g., inverted index, bitmap index, b-tree, ART, hash, etc.) are identified and partial/hybrid indexes of those types are generated for those parts of the index for which it is determined that an index of the alternative type would (better) achieve the applicable optimization criteria. A hybrid index is a composition of different index types functioning as a single logical index.

In some embodiments, a copy of data held in a separate relational database, such as a shadow copy in original data store 120 in FIG. 7, is used to run extensive analysis on the raw data in order to optimize the type of index generated (i.e., b-tree, ART, Hash, etc.).

In various embodiments, inverted indexes are used for secondary indexes. An inverted index stores a mapping from content, such as words or numbers, to its location in a data structure.

Existing database products typically require a database administrator to choose which columns of a table to index and the kind of index (B-tree, ART, etc.). To attempt to improve performance in a typical system, a database administrator may make a change and track/measure the result. This process is manual and must be reevaluated constantly as access patterns frequently change. In various embodiments, the system disclosed herein automatically monitors access patterns and can be configured to automatically make changes to add/delete indexes, change the type of index, merge or split indexes, etc., to achieve the most optimal set of indexes.

Indexes may be organized into a set of “buckets”, e.g., to achieve efficiency in storage and/or access time. In some embodiments, in a system as disclosed herein the storage format of one bucket comprising an index may be different than that of another bucket, achieving a further degree of optimization at the sub-index level. For example, different buckets comprising an index may be organized and/or stored as an array of record identifiers, a bitmap of record identifier, and/or a run-length encoding of record identifiers, depending on what is most efficient with respect to each part (e.g., bucket) of the index. In various embodiments, this approach allows the system to optimize for the amount of data in an index bucket, optimize for space vs performance, and optimize for space for less utilized index values and performance for more utilized index values.

In various embodiments, the system indexes “groups like” data in a way that allows different organizational structure per group. For example, in an index on a “YES/NO” column, with only a handful of YES values and a majority of NO values, the “YES” data may be structured as a pointer to the data while the “NO” data may be structured as a Run Length Encoded data structure in order to compress the index while maintaining (or even increasing) the performance of the system.

In various embodiments, automated processing (e.g., machine learning) is performed to determine specific solutions to optimize data storage and/or access to achieve high level objective(s). In some embodiments, high level objectives may be indicated by an administrative user, e.g., via a user interface. Examples include without limitation enabling a user to indicate and balance consideration of high level objectives such as cost, storage space, CPU usage, other resource use, performance, access latency, response time associated with one or more queries, etc., with potentially different objectives and/or relative priorities being indicated for different sets of data, different geographic areas, different times of year, etc.

For example, a retailer may indicate an objective to optimize for speed/performance during the peak shopping holidays but to instead optimize for monthly spend (e.g., for CPU, storage, bandwidth, and/or other resources) during slow seasons (e.g., when sales volume is below a threshold). In various embodiments, a machine learning layer would optimize/re-optimize indexes and/or transformation of customer data as two ways to achieve the desired objectives.

In some embodiments, users of the system (customers or service providers) are provided an interface (e.g., GUI, configuration data, etc.) to designate resource profiles and have the system alter itself in order to maintain the target profile. Examples include: optimizing for better response times during high-value sales periods, optimizing for resource utilization during periods of high usage allowing the system to degrade gracefully, and optimizing such that specific high-value data items are higher performing/more responsive and lower value items are lower performance/less responsive and use fewer resources. Examples of real-world triggering events where this dynamic performance profiling may be performed include: Black Friday sales, Thanksgiving travel, national media exposure giving rise to a spike in activity for a website, app, product, etc.

To determine what changes are made in order to maintain or achieve the targeted performance and resource profile, the system in various embodiments uses one or more of business rules, heuristics, and/or machine learning/artificial intelligence techniques.

In some embodiments, optimization to achieve high level objectives may be performed at least in part by defining and finding a solution to minimize a cost function. The cost function may embody and quantify multiple cost elements, each weighted to an extent corresponding to the user's (data owner's) high level objective(s). The cost function may reflect the cost associated with anticipate data access operations under various scenarios. In some embodiments, the system iterates through multiple and/or many possible combinations of data structures, indexes, and other techniques as disclosed herein to determine an optimal set of data structures, indexes, etc. to best achieve the user's high level objectives. For example, the feasible solution with the lowest cost, applying the cost function, may be selected. The cost function can be multi-variate or based at least in part on a computational model such as Monte Carlo or Bayesian model.

In some embodiments, high level objectives may be expressed separately and may be different (tunable) for each of a plurality of business applications and/or industries (“verticals”) with respect to which data is accessed. In some embodiments, a given user may be in a single “vertical” and solutions found previously to be optimal for other users in the same vertical may be implemented and/or tested to determine whether the same and/or a nearby (similar) solution may best achieve the user's high level objectives. Membership in particular verticals provide a basis upon which optimizers can build, as opposed to starting from a blank state.

References to machine learning herein include but are not limited to analytic and symbolic processing such as deductive logic programming, inductive logic programming, qualitative differential equations, statistical and neural net models developed an/or executed individually or in combination.

In various embodiments, data access is optimized in two or more stages. For example, to speed deployment and access, in some embodiments, data at first may be ingested and stored in the format and data structures in which the data was stored at the origin database 102, e.g., as a set of associated tables. A copy of the data is used, along with configured and/or observed queries and/or access patterns, to generate a more optimal set of locally accessible data structures and indexes. The optimal data structures are created, and the user's data is transformed by storing applicable portions in the local optimized data structures.

In various embodiments, a copy of the original data and/or the optimized data as currently optimized may be used on an ongoing, periodic, event-triggered, or other basis to attempt to further optimize one or more of the data structures and/or format, indexes, query optimization, query caching, etc. If a more optimal solution is found, in various embodiments the more optimal solution (data structures, transformation, indexes, etc.) is implemented, and once ready the data in the more optimized format, etc. is used to respond to requests. Processing to attempt to even further optimize data access may then and/or subsequently be performed, and so on.

In various embodiments, data in its original format, as received from the origin database, and/or data in previously-optimized form, if not superseded (e.g., by new or updated data) is retained and used to service requests that cannot be serviced by the data as optimized currently.

For example, in some embodiments, if a data access node receives a request that it will not be able to service within an acceptable delay, the data access node redirects the request to a valid alternative data source. A valid data source is one that provides usable data responsive to the request. Usable data may include, without limitation, data that meets locality requirements (for easy, fast access), has a data structure optimized in a way that does not inject new overheads for the request, has policies that allow access to the copy of the data for a particular user, or is current (up to date). In some embodiments, client system requests that cannot be serviced at the data access node, e.g., because required data has not been ingested, etc., are serviced by making a call to the origin database to obtain results required to respond to the client system request.

FIG. 11 is a flow chart illustrating an embodiment of a process for query optimization. This process may be implemented on or by query optimizer 120 of FIG. 7. This process can be performed as part of another process such as 802 of FIG. 8. The process will be explained with reference to the example shown in FIGS. 12A and 12B. FIG. 12A shows an example of an index in a first state. FIG. 12B shows an example of an index in a second state.

The process begins by receiving a query (1100). A single query can be executed through different algorithms or rewritten in different forms and structures. Query optimization attempts to determine the most efficient way to execute a given query by considering several (which may be numerous) possible query plans and choosing those best among them.

The process determines whether the query has been previously executed (1102). If the process has previously executed the query, the process looks up indexes previously used to execute the query (1104). Using previously used indexes is more efficient than repeating work that has been previously done.

Otherwise, if the query has not been previously executed, the process proceeds to cache a query execution plan for the query (1106). In some embodiments, query caching in a system as disclosed herein may include caching a query execution plan, including for example an identification of the indexes used to execute the query previously. Some data may be accessible via more than one index, and in various embodiments a data access node as disclosed herein may include in a query cache an identification of which of the two or more available indexes should be used if the query were to be received again. A query cached in this manner may enable the query to be executed more quickly even if the potential response data have changed. The cached result is retained for as long as none of the indexes used by that query are updated. In various embodiments, the process returns to 1100 after performing 1006 or the process may simply terminate.

Consider the following example query: Select * from products where brand=“Premium Brand” and price>200

This query hypothetically would return a relatively large number of data/rows if almost every “Premium Brand” product was over $200. Because the query returns so many records, it is expensive to execute. In various embodiments, a system as disclosed herein caches the result of the example query and tracks any changes to the brand and price index. If either index is updated (insert/update/delete), then the cached result is removed. In some embodiments, changes are tracked at the value of the index level, tracking changes to the brand index strictly for the value of “Premium Brand” and the price index for changes to any price over $200. If the brand is no longer a Premium Brand or if the price falls below $200, the cached result is removed.

Referring to FIG. 12A, which shows an index containing three items that satisfy the example query. This index or a query execution plan corresponding to this index is cached at 1006. Suppose the price of one of the items, Glen Moray 22, changes so that it no longer satisfies the example query as shown in FIG. 12B. The cached result is removed. Either a subset of the table or the entire table is removed depending on which is the more optimal approach for observed access patterns.

Typically, if a system is configured to provide a pre-defined number (minimum number, etc.) of results, the definition is static and can result in long query response times, e.g., if the system has to keep searching for additional response records to be able to return a result.

In various embodiments, new query language facilities are defined, implemented, and used to respond to queries more quickly. In some embodiments, an “AtLeast” operator and associated functionality is defined and implemented to enable (a series of) queries until at least a given number of records have been accumulated/returned. In other words, the data access node can specify a minimum number of records to return as a result. “AtLeast” will run each query supplied to the function until “AtLeast” X results have been accumulated. In various embodiments, it will always return the full result set from any query in the query list that is invoked. For example, if queries A, B, and C have a desired result set of 10 rows and query A returns 8 rows, then query B will be invoked. If query B returns one row, then query C will be invoked. If query B returns more than 1 row, then all of the rows from query A and B will be returned (at least 10 rows). In some embodiments, this is the functional equivalent to a SQL UNION operator with the ability to early terminate the fall through to the next union segment based on the desired number of rows being returned.

In some embodiments, an “AtMost” operator and associated functionality is defined and implemented to enable (a series of) queries until at most a given number of records have been accumulated/returned. In other words, the data access node to specify a maximum number of records to return as a result. “AtMost” will early terminate the running query when the targeted number of rows have been identified. For example, if the desired result set is at most 10 rows and 8 rows are returned from query A, then maximum of 2 more rows are accumulated from query B and/or query C would be returned. That is, if query B returns only 1 row, then query C will be invoked to return 1 more row. If query B returns 2 or more rows, then only two rows will be taken from query B for the result set and query C will not be invoked.

In various embodiments, new operators such as “AtLeast” and “AtMost” enable a user to specify a series of queries with the intent of progressively building a larger final result set.

An example that illustrates the “AtLeast” function as implemented in various embodiments is a search box on a web page to ensure that at least X records is returned. For example:

### Select *

From products
Where atleast(10, brand=“BrandOne”, brand=“BrandTwo”, product_type=“Phone”)

In the above example, in various embodiments, a data access node as disclosed herein would search first from products of the brand “BrandOne”. If at least ten results were returned it would stop and provide those results. If fewer than ten results were returned it would go on to find products of the brand “BrandTwo”. Again, if at least ten results were returned it would stop and provide the combined results. If fewer than ten results were returned it would go on to find products of the type “Phone”, etc.

In various embodiments, a data access node as disclosed herein is capable of transforming any query based on string equality into a query that can correct for typographical/spelling errors without any end-user optimization, data duplication or transformation, while maintaining the ability to fully utilize indexes. In some embodiments, this is done by transforming a string to an enumerated list of known to be valid values via a sophisticated edit distance formula in combination with tracking all legal values in an index.

The following example illustrates query transformation based on edit distance and known indexed values in various embodiments:

### Select *

From products
Where fuzzy(description, “chacalate cookys”)

Typical databases would require all of the possible misspellings to be added to the index by the user/application in order to allow the index to be utilized. In various embodiments, in a data access node as disclosed herein, “chacalate” will match “chocolate” and “cookys” will match “cookies” without any direct use effort of any kind. It will then use those correctly spelled words automatically on the description index, which improves the processing speed.

Optimization reduces the difference between a desired outcome and actual outcomes. Optimization techniques include without limitation:
1. Generation and/or selection of particular data models best suiting the desired outcome
2. Generation and/or selection of particular query plans best suiting the desired outcome
3. Improvements in the efficiency of generating and/or selecting query plans from queries
4. The use of 1, 2, and/or 3 in combinations best suiting the desired outcome

Data stored in the origin database may change over time. Likewise, patterns and requirements to access data may change over time. Additionally, the optimization objectives and/or priorities of data owners and users (clients) may change over time. For example, from time to time, policies may be changed. In some embodiments, the techniques disclosed herein optimizes the process of changing between policies by:
1. Anticipating the actions necessary to accommodate the new policy
2. Optionally determining the best-fit combination of those actions that yields the desired outcome within the policy constraints
3. Optionally creating an imperative plan that, when executed, causes the system to meet the desired outcome.

In various embodiments, to ensure optimized access to data is provided as data, behavior, and/or requirements change, data access optimization is reevaluated and may be updated dynamically. Data access optimization may be reevaluated continuously, from time to time, in response to triggers or events, upon observing via automated process a change in data, access patterns, etc.

The system can respond to policy changes by dynamically updating data access optimization. FIG. 13 is a flow chart illustrating an embodiment of a process for dynamically updating data access optimization. This process may be implemented on or by system 100 of FIG. 1 or FIG. 7. This process may be performed as part of another process such as step 802 of the process of FIG. 8.

The process begins by receiving a subset of data included in a set of origin data (1300). An example of this step is 800 of FIG. 8.

The process applies a first transformation to at least a portion of the subset of data to provide a first optimized data (1302). An example of this step is 802 of FIG. 8.

The process provides the first optimized data to one or more of the data access node(s) (1304). An example of this step is 804 of FIG. 8. The process then proceeds to perform one or more further optimizations until a stop condition is met (at 1306 or 1312).

The process determines whether to apply a further optimization (1306). The determination to apply a further optimization may be based on various triggers including, without limitation, a change in: one or more optimization parameters, a policy, a cost function, event trigger such as a query, a type of query, a source data being changed, a source data being accessed, a quantum of change in source data, or an external event as further described herein.

If a further optimization is not needed, the process proceeds to 1312. Otherwise, if a further optimization is to be applied, the process proceeds to apply a second transformation to at least a portion of the subset of data to provide a second optimized data (1308). An example of a transformation is step is 802 of FIG. 8. For example, the transformation includes creating a new index.

The process may determine to perform a second optimization because data, behavior, and/or requirements have changed since a previous optimized. In order to ensure optimized access to data, the process re-evaluates the optimization and may update the optimization dynamically. In various embodiments, one or more of the following may be changed to dynamically update the optimization of data access: data ingested, manner in which data is transformed and/or stored, types of index used, number, and mix of indexes, etc. Data access optimization may be reevaluated continuously, from time to time, in response to triggers or events, upon observing via automated process a change in data, access patterns, etc. In various embodiments, the process observes data access while the first optimization is being or has been performed, and the further optimization is applied based on the observed access of the first optimized data (as deployed).

The process provides the optimized data to one or more of the data access nodes (1310). Here, the optimized data may or may not overlap with the earlier data optimized at 1304. That is, at least a portion of the data optimized at 1304 is further transformed at 1308 and provided at 1310 or at least a portion of the data optimized at 1308 may be different from the earlier optimized data. An example of providing optimized data is 804 of FIG. 8.

The process determines whether the process is done (1312). Various factors can be considered in determining whether the process is complete. In various embodiments, the process makes the determination in a similar manner to 1306 and may determine that the process is done in response to triggers or events, upon observing via automated process a change in data, access patterns, etc. In various embodiments, the process makes the determination in response to other types of stop conditions such as a threshold time having elapsed or processing resources having been consumed.

In various embodiments, the process may perform additional steps between different optimizations (e.g., between the first optimization (1302) and one or more further optimization (1306)). For example, the process can perform or receive a result of machine learning, where the machine learning provides one or more further optimizations.

As an example, consider a policy named “instant” with a desired outcome where clients experience minimum latency, as measured by the delay between their expression of a query and the first set of usable results has been received. To accommodate this policy:
1. Data models minimizing query execution time are implemented by manifesting data model instances using data from the origin store or existing data model instances,
2. Query plans minimizing the execution time for these data model instances are selected and executed
3. Optionally, results are transformed in a way that minimizes the time needed for those results to be used effectively by the client.

A new policy, “cheap,” is introduced with a desired outcome where clients experience latency that is less than some maximum value yet not guaranteed to be minimal, but where the cost of operating the system is minimized. To accommodate this policy:
1. Data models minimizing query cost are implemented by manifesting data model instances using data from the origin store or existing data model instances,
2. Query plans minimizing the execution cost for these data model instances are selected and executed
3. Optionally, results are transformed in a way that minimizes the cost of those results to be used effectively by the client.

A cost function used in the techniques disclosed herein models costs using parameters including but not limited to constants, time and/or duration, functions of system state, and functions of combinations of such functions.

In various embodiments, an optimization may be based on an observed, configured, and/or otherwise anticipated set of data access patterns. For example, an administrative user may initially specify a set of queries expected to be received frequently. Over time, deviations from the expected data access patterns may be detected. For example, automated processing may be performed to detect actual, observed data access patterns that deviate from previously-observed and/or configured patterns. In response to detecting a change in data access patterns, in some embodiments, a dynamic reevaluation of data access optimization may be performed. If a more optimal solution to achieve the current policy objectives is determined, the more optimal solution is implemented. For example, data may be subjected to a different transformation upon ingestion, or one or more indexes may be changed to a different type of index, etc.

In another example, data access patterns may change seasonally, or new patterns may emerge over time, such as data access patterns associated with users in a new geographic service area or in a geographic area undergoing rapid changes, a catastrophic event, etc.

In another example, a celebrity or other opinion leader may mention a new favorite book, and suddenly there is a 10× spike in book searches. In various embodiments, a system as disclosed herein may dynamically add an index on product type, in order to facilitate searches for books. 48 hours later, the number of book searches return to their normal levels and the system may delete the index on product type as it is surplus to the requirements of the current policy.

In various embodiments, indexes used to provide access to data may be changed dynamically to provide better optimized access to data under different and potentially rapidly changing conditions. Indexes may be divided in different ways, or different types and/or mixes of index type may be used.

In some embodiments, optimization is performed at least in part by performing automated processing to minimize a cost function. The cost function is evaluated with respect to various combinations of data transformation, indexes, etc., and a solution that minimizes overall cost is selected. In some embodiments, dynamic updating of an optimized data access solution is performed at least in part by reevaluating the cost function, taking into consideration the observed changes in the data, data access patterns, etc.

In some embodiments, cost function reevaluation and/or other processing to dynamically determine an updated optimization may be performed with respect to a copy of data that has been stored separately from the data used to service client requests, e.g., a “sandbox”, to ensure client requests are serviced while processing to determine an updated optimization is performed.

In various embodiments, the system automatically monitors all queries for target performance characteristics. In some embodiments, query optimization includes looking at any or all of the possible data access optimizations for a given query, where computationally feasible. In a typical database, query optimization may include choosing between two indexes (because they can only use one of the indexes). In some embodiments, a system as disclosed herein performs dynamic and more granular query optimization on the fly, such as creating a compound index or by creating a new index on a field. The system may determine which kind of index to use from the pool of different index types.

For example, a query optimizer determines that the system should use two more indexes concurrently and creates a compound index by fusing the indexes. As another example, the query optimizer may create an index on a field where one previously did not exist, based on the optimizer being informed that many queries provide constraints on the value of that field but there is no usable index, or an existing index is not sufficient. For example, many pharmacies validate identity for prescriptions using the purchaser's name and date of birth. A table containing prescription information might be designed to use an index on the person's name; the record is quickly located using the index, then the person's data of birth is matched against the record by the pharmacist. Some pharmacies, however, ask for the date of birth first, as it often reduces the number of entries for people with the same name, making the search less error-prone and potentially less lengthy. A system as disclosed herein detects this situation, and either recommends the creation of the date-of-birth index, or creates it automatically, depending on established policies.

Suppose some users are looking up people by city while other users are looking up users by zip code. In a normal RDBMS, this is accommodated by having an index on city and another index on zip code. Now, a new population of users starts to look at people based on both city and zip code. A traditional database may optimize the query (query optimization) and pick one index or the other as the better one to use. The system as disclosed herein performs the query optimization process to determine whether it should pick one index or use both indexes (merge the results of both indexes) for better performance.

In some embodiments, the system also runs offline analysis of the queries and/or performs transformations offline and can determine on its own if it should create a compound index of “city, zip code” or “zip code, city” (the order matters) and automatically generate the new index. In some embodiments, the system automatically determines that this new index replaces one of the previous indexes because the new index provides the same functionality and the same or a better level of index performance than the previous index. Benefits of using the new index include, without limitation, returning resources to the system or lowering the customer's billing.

In some embodiments, this offline analysis also picks up that there is a new access pattern of looking for people based on having children who are interested in school open enrollment season. The system automatically adds the index(es) needed to support this new access pattern. Later when open enrollment season ends, the system removes this index as those types of queries fall out of usage.

In various embodiments, the tradeoff between performance and resource utilization can be transparent (e.g., how the system maintains its performance guarantees) or be presented as recommendations for the customer in order to manage costs.

In various embodiments, dynamic update of data access optimization may be triggered and/or performed in response to a change in policy. In some embodiments, an administrative user interface is provided to enable a user to indicate a policy change, to adjust an indication of relative priority of potentially competing policies or desired outcomes (e.g., cost versus performance), indicate that new or changed queries are to be anticipated, etc.

In some embodiments, dynamic update to data access optimization may be performed in response to and/or according to a schedule or calendar indicated by a policy owner. For example, periods in which unusually heavy traffic, sales, etc. are anticipated may be designated, resulting in a different data access optimization being determined and implemented for such peak activity or demand periods.

In various embodiments, machine learning techniques are used to determine and dynamically update data access optimization. Solutions generated for a data owner may be “learned” and applied to optimize access to other data of the same data owner and/or to other data of that data owner under similar circumstances. For example, optimizations determined for a first data owner may be applied or considered as a candidate to optimize access to data of another data owner having similar attributes. Data owners may have similar data, data formats, or structures as stored in the origin database, similar access patterns, etc. Data owners in a same line of business or “vertical” may be considered as candidates to apply optimization learned for one data owner to optimize access to data of another data owner.

For example, while every e-commerce site has a unique product description, there are fields that are common to all descriptions such as SKU, description, price, etc. In various embodiments, when a new customer describes their schema, a system as disclosed herein may use machine learning to identify fields that have candidate key data, despite different naming, and automatically apply indexes to the fields that are known to be highly utilized by other data owners in the same “vertical” or industry.

Queries comprise a number of different specifications, including but not limited to directives for sorting, directives for selecting only parts of the data offered by a local data instance, and ways of combining data from different elements of a data model. The system analyzes the queries at this level of detail as well as a complete unit. Specific values and trends in the usage of these query substituents combined with the desired outcome and constraints specified by a policy define a correction function used to train optimization models. Suppose that a policy specifies a desired outcome of minimizing the time needed to execute a query, with constraints that include using no more than 2 megabytes of memory as part of the optimization. In this example, queries make use of a particular field F sorted in ascending order. The optimizer concludes that an ascending index on field F would be beneficial. Further, the optimizer determines that for the values present in field F in the current node, an index of the field would comprise 750K bytes of memory. The optimizer then causes the index to be created, becoming available once completed for all future queries that need it. Optimization models include but are not limited to logic programming, deductive, and inductive inference, trained networks models, separately and in combination.

In various embodiments, data is distributed geographically across two or more systems based at least in part on physical proximity to the user(s) requiring access to that data. A determination is made as to how to optimize data required at each data access node by applying business rules, dynamically analyzing user access via heuristics and/or machine learning/AI, and/or a combination. For example, the determination can be made by distributing a subset of entire records (horizontal partitioning), distributing a subset of parts of the records (vertical partitioning), and/or by combining two or more pieces of data into a more resource efficient/optimized organization. Examples of use cases include, without limitation, different inventories based on geolocation in retail and seat availability in bulk travel.

In various embodiments, a system or other node, module, or process dynamically determines which data or parts of data should be copied to a new location, closer to the users of that data, based on business rules or access patterns.

Typical business data housed in a computer system have a point of origin that allows the owner of the specific data control (who has access, who can alter the data, etc.). With users located around the world, access to this data is expensive and slow. In various embodiments, making a copy of the data available at one or more data access nodes as disclosed herein allows faster access by moving the data physically closer to the users of this data. Copying all of the data is expensive, both in machine resources and time. In various embodiments, both a business rule and heuristically determined identification of the part of the data that are being accessed by disjoint users may be used to optimize for resource utilization and performance.

In various embodiments, an unlimited number of copies of the customer's data may be made, each copy (potentially) being stored in a different data access node, which supports one or more of the following: fast local failover, sharding, and geolocating data closer to customers (for reduced latency).

In various embodiments, the customer (data owner) is able to specify geolocations and rules for data movement. For example, the system in some embodiments would be configured to automatically identify an increase/decrease in traffic for specific geolocations and add/delete geo nodes (e.g., data access nodes at different geo-locations) to meet the customer's performance/spend objectives.

In various embodiments, costs associated with the transmission and storage of data are represented as cost functions compatible with query optimizer 120 and data optimizer 112.

FIG. 14 is a flow chart illustrating an embodiment of a process for providing data access optimized across access nodes. This process may be implemented on or by system 100 of FIG. 1 or FIG. 7 or one or more systems 204, 206, and 208 of FIGS. 5 and 6. This process can be performed as part of another process such as 804 of FIG. 8.

The process begins by receiving a subset of data included in a set of origin data, at least a portion of the subset of data being optimized for access from the data access node (1400). In various embodiments, data access optimization techniques disclosed herein may be applied differently to the same original data (from an origin database) or to different original data (e.g., at least some of the data received by each system is different from that received by another system) with respect to diverse systems, such as geographically distributed systems, as in FIGS. 5 and 6 or a hybrid of the systems shown in FIGS. 5 and 6 in which data, optimizations, or other information are shared between systems at different locales. For example, which subset of data is ingested, how data is transformed and/or stored, and which types and mixes of (partial) indexes are generated and used may be different at different systems (access nodes). A central or other shared knowledge store (storing optimizations, transformed data, etc.) may provide federated access to different systems to enable different systems to share optimizations and the like.

In various embodiments, each system or data access node (examples are depicted in FIGS. 5 and 6) is associated with a corresponding set of users, and each system or data access node provides access to the corresponding set of users. As described herein, each system or data access node is in physical or network proximity to a corresponding set of users, which may improve response times to queries from the corresponding set of users.

For example, the respective data access nodes at each of a plurality of geographic locations (region, country, continent, etc.) may each require a different subset of data. Specific data, may be identified—by a predicate (relational database view), for example—to allow a specific slice of the overall data to a given data access node associated with a corresponding geo-location. In various embodiments, data can be sliced horizontally (a subset of rows), for example to locate only the subset of products available to that region, and sliced vertically (a subset of fields) to optimize for the data required by local business rules for that region. As an example, an electronic commerce (e-commerce) retailer servicing Europe, tailors data to specific natural languages in different countries where those languages are prevalent.

The process provides locally optimized access to the subset of data (1402). In some embodiments, data access optimization techniques disclosed herein may be applied differently at different data access nodes to achieve different high level objectives at each node. For example, at one node, the data owner may have indicated a desire to optimize based on cost over performance, or to do so to a different extent than at another data access node. In some embodiments, the same cost function may be used at each node, but tuned differently based on different high level objectives indicated by the data owner with respect to different nodes. In some embodiments, local optimizations can include optimizations determined locally and/or optimizations determined by another node that has shared optimizations with the local node.

In various embodiments, the same or similar data may be transformed and/or indexed differently at different access nodes, depending on the attributes of the data access node, including without limitation access patterns, queries, high level objectives, costs, resources, infrastructure, etc. of the respective access nodes.

In various embodiments, data access optimization may be implemented differently at each of a plurality of data access nodes, as disclosed herein, and at each node and/or across the nodes the optimizations and the differences between the data access optimizations across access nodes may change over time. For example, data access patterns, requirements, and objectives at each node may evolve over time or may change within an annual or other periodic cycle (e.g., seasons).

In various embodiments, business rules, along with static and dynamic analysis of data access are used to determine the optimally minimal subset of the data to be replicated for each data access node such that the required data is available in the most cost and time effective manner prior to the users request for that data.

In various embodiments, data storage, indexing, etc. may be optimized based on the rules of the country or other location(s) in which the data is “at rest”, e.g., stored physically in digital form. This specifically addresses, but it not limited to, addressing data security requirements based on geographic and/or political boundaries.

In some embodiments, optimization based on location “at rest” reflects horizontal or vertical partitioning of the data based on the geo-location of the data (e.g., country of “at rest”). If different data is stored on different access nodes, in various embodiments different optimization of the data is performed with respect to each node to reflect which pieces of the data are available/not available at that node.

Dynamically determined horizontal partitioning can be performed as follows. Suppose the system detects over time that users of Node 1 are only accessing data subset 1 and users of Node 2 are only accessing data subset 2. For example, Node 1 users never purchase products from a specific vendor while a bulk of the purchases on Node 2 are from that vendor. In various embodiments, the system would self-optimize by causing only the subset 1 data to be maintained at Node 1 and only the subset 2 data at Node 2.

In some embodiments, data not provided to a node (e.g., not “at rest” there) would be “flagged via metadata”. If a query requiring such data were received at the node, the query would be run on a more remote (farther away from the user and hence a little slower) node where the complete dataset would exist.

Vertical partitioning can be performed as follows. The system detects over time that users of Node 1 always look at specific parts of records—for example, price and stock because they are running analytics, whereas Node 2 users are always looking at descriptions because they are in marketing. In some embodiments, the system would “strip/remove” at each node the columns that are not needed at that node. In some embodiments, metadata would reflect the existence and location of the removed data at one or more other nodes, so queries that break the identified pattern could automatically be routed to nodes with the full (or missing part of the) data set. In some embodiments, the detection of repeated access for non-local data causes a policy owner to be alerted, prompting them to change the distribution policy, and/or change the distribution policy temporarily and/or permanently, depending on policy settings.

In various embodiments, horizontal and/or vertical partitioning as disclosed herein provides one or more of the following benefits: globally uses fewer resources and/or use the available resources for more performance/support more users; allows the customer to segment the data based on security requirements of the users that are allowed to only see parts of the data; with different datasets on a node, the system is able to optimize for that specific dataset and access patterns

Additional optimization examples will now be described. Suppose Node 1 supports an e-commerce site, while Node 2 is used for sales analysis. The system detects that Node 1 always access data stored in several tables (SKU, vendor description, store location, etc.) in the System of Record (and reflected in the customers schema captured via the admin console). The system automatically creates a compound object consisting of the data from all of the tables, so when a customer looks at a product (SKU), they get all of the data without the need to do joins. Node 2 does not have a desirable common access pattern, so the system keeps the data in the customer defined table (unaltered).

An e-commerce example will now be described. Suppose Country 1 has strong preferences to only purchase local products. Because of this, the amount of inventory is dramatically reduced compared to country 2, which tends to purchase based on price. In geo-location 1, the system optimizes access based on Brand and Country of Origin. In geo-location 2, the system optimizes access based on price.

A few examples of data transformations that may be performed will now be discussed. FIGS. 15-17 illustrates an example of data obtained in some embodiments. Referring to FIG. 15, assume two tables, “Person” and “Address,” where each address is associated with a person, identified by a match between “person.id” and “address.person_id” as shown in FIG. 15. The description of a person that includes their address could be represented by the table shown in FIG. 16.

In this result, the columns from each table are combined into a single set of columns, with redundant columns eliminated to present the results of JOIN operators in SQL. However, it is possible for a person to have more than one address. One way to return data in this case is to return two rows, one row for P1.Address1 and another row for P1.Address2. Another way to return data in this case is to return a single row with additional sets of columns for the non-redundant columns.

Rather than extending the row above with more columns, any associated addresses can be embedded into the person table as a single column. The column would hold an array of none, one, or more addresses for each person. Such an organization would yield the structure shown in FIG. 17.

Address is manifested as a data type called a struct, which allows something that looks like another table to be embedded. In this example, this means when a person's address is required, the system already has it upon reading the “person” record, because the address is part of the person, saving the lookup that is present in the above traditional relational design. Also note that unlike “denormalization”, the table structure for the address information is maintained instead of simply “flattening” the table person to include extra fields as illustrated in FIG. 16.

An example of this in a textual representation as implemented in various embodiments is:

```
Table Person:
ID
Name
Address:
[
  {
    Street
    City
    State
    Zip
  },
  {
    Street
    City
    State
    Zip
  }
}
```

Where the address are now stored in an array. For example, address [1] stores a primary address and address [2] stores a vacation address based on a user-definable storage convention.

In one aspect, such embedded formats maintain the association of addresses to people in a more natural way than repeated rows or adding extra columns (FIGS. 15-17). This may be preferred for some applications because embedded formats map easily to data structuring conventions in modern computer languages and systems.

In various embodiments, the inclusion and placement of metadata, such as the name, data type, and position of columns in a table may be factored to occupy a minimum of space or reduce transmission time. Alternately, full metadata can be included on every array item, optimizing the representation of a single or small set of rows for low-latency rendering. These techniques may also be mixed at any level to suit specific needs.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system comprising:
a communication interface; and
a processor coupled to the communication interface and configured to:
receive via the communication interface at least a subset of data included in a set of origin data;
transform at least a portion of the subset of data in a manner associated with providing access to at least said portion of the subset of data in a manner that is optimized with respect to one or more parameters; and
provide access to the transformed subset of data to an associated set of one or more users.

2. The system of claim 1, wherein the set of origin data includes data associated with at least one of: a database, a flat file, or a data stream.

3. The system of claim 1, wherein the set of origin data is associated with at least a portion of one or more origin databases.

4. The system of claim 1, wherein the system is included in a plurality of systems, wherein each system includes at least one of a data access node or a data ingestion and transformation module.

5. The system of claim 4, wherein the plurality of systems includes a first set of one or more systems that performs optimizations differently from a second set of one or more systems.

6. The system of claim 4, wherein the plurality of systems includes a first set of one or more systems that performs the transformation differently from a second set of one or more systems.

7. The system of claim 4, wherein the plurality of systems is configured to access a plurality of different origin databases.

8. The system of claim 4, wherein systems in the plurality of systems are associated with at least one of: different or overlapping subsets of data.

9. The system of claim 4, wherein the subset of data includes data from different origin databases, and the transformation operates on combined data from the different origin databases.

10. The system of claim 4, wherein systems in the plurality of systems are configured to coordinate with each other to share optimizations.

11. The system of claim 4, wherein systems in the plurality of systems are configured to coordinate with each other to self-organize to share work including by optimizing or transforming at a least a first portion at a first system and at least a second portion at a second system.

12. The system of claim 1, wherein the system includes a data access node remote from an origin database.

13. The system of claim 12, wherein the origin database is at least one of: a system of record or a relational database system.

14. The system of claim 1, wherein:
the set of origin data is stored in tables; and
the subset of data includes a subset of rows in the tables.

15. The system of claim 1, wherein:
the set of origin data is stored in tables; and
the subset of data includes a subset of fields in the tables.

16. The system of claim 1, further comprising updating the received at least a subset of data.

17. The system of claim 16, wherein updating the received at least a subset of data includes at least one of: receiving a publication by a data source or subscription to the data source.

18. The system of claim 16, wherein updating the received at least a subset of data includes receiving data as a batch.

19. The system of claim 18, wherein the received batch of data is received at least one of: on a predetermined schedule or based at least in part on an event-based trigger.

20. The system of claim 19, wherein the event-based trigger includes at least one of: a query, a type of query, the set of origin data being changed, the set of origin data being accessed, a quantum of change in the set of origin data, or an external event.

21. The system of claim 1, wherein transforming at least a portion of the subset of data includes at least one of: creating a new data structure or changing a data structure.

22. The system of claim 21, wherein transforming at least a portion of the subset of data includes capturing query metadata for query compatibility with the new data structure or the changed data structure.

23. The system of claim 1, wherein transforming at least a portion of the subset of data includes modifying a compound data structure including by storing one record within a field of another data record as an array.

24. The system of claim 1, wherein transforming at least a portion of the subset of data includes creating a new index.

25. The system of claim 1, wherein the subset of data is determined based at least in part on a set of queries.

26. The system of claim 25, wherein the subset of data includes at least one of: a static configuration or analysis of a specified set of queries.

27. The system of claim 25, wherein the subset of data is observed over time.

28. The system of claim 25, wherein the subset of data is observed using machine learning.

29. The system of claim 1, wherein transforming at least a portion of the subset of data includes:
initially accessing an untransformed subset of data;
learning over time; and
implementing at least one optimization on the subset of data based on the learning.

30. The system of claim 1, wherein transforming at least a portion of the subset of data is performed offline.

31. The system of claim 30, wherein transforming at least a portion of the subset of data is performed at least one of: continuously or until currently optimized.

32. The system of claim 1, wherein transforming at least a portion of the subset of data includes:
operating on a production database or copy of the production database; and
selecting another data structure to organize the subset of data based on a set of queries.

33. The system of claim 1, wherein the one or more parameters by which the subset of data is optimized includes at least one of: CPU, storage, access latency, or response time associated with at least a subset of queries.

34. The system of claim 1, wherein the one or more parameters by which the subset of data is optimized includes a cost function.

35. The system of claim 34, wherein the cost function is multi-variate.

36. The system of claim 34, wherein the cost function is based at least in part on a computational model.

37. The system of claim 1, wherein the one or more parameters by which the subset of data is optimized includes a tunable high level objective.

38. The system of claim 1, wherein the processor is further configured to halt the transformation in response to obtaining a threshold number of results.

39. A method comprising:
receiving at least a subset of data included in a set of origin data;
transforming at least a portion of the subset of data in a manner associated with providing access to at least said portion of the subset of data in a manner that is optimized with respect to one or more parameters; and
providing access to the transformed subset of data to an associated set of one or more users.

40. A computer program product embodied in a non-transitory computer readable storage medium and comprising computer instructions for:
receiving at least a subset of data included in a set of origin data;
transforming at least a portion of the subset of data in a manner associated with providing access to at least said portion of the subset of data in a manner that is optimized with respect to one or more parameters; and
providing access to the transformed subset of data to an associated set of one or more users.
